(19) United States
(12) Patent Application Publication
(10) Pub. No.: US 2024/0079608 A1
(43) Pub. Date: Mar. 7, 2024

(54) FUEL CELL VOLTAGE PICKUP CONNECTOR

(71) Applicant: Interplex Industries, Inc., East Providence, RI (US)

(72) Inventors: Jeng-De Lin, Lapeer, MI (US); Jeffrey Parrish, Temperance, MI (US)

(21) Appl. No.: 18/029,776

(22) PCT Filed: Oct. 18, 2021
(86) PCT No.: PCT/US2021/055445

§ 371 Date: Mar. 31, 2023

Related U.S. Application Data
(60) Provisional application No. 63/093,645, filed on Oct. 19, 2020.

(51) Int. Cl. H01M 8/0247; H01M 8/04537; H01R 12/58; H01R 13/11; H01R 13/641

(52) U.S. Cl. CPC H01M 8/0247; H01M 8/04552; H01R 12/58; H01R 13/113; H01R 13/641; H01R 13/639

(57) ABSTRACT

A voltage pick-up connector for connection to a bipolar plate of a fuel cell. The voltage pick-up connector includes a housing having a housing slot for receiving the bipolar plate. A pair of electrically conductive contact plates are disposed inside the housing and have contact elements for engaging the bipolar plate. An actuator is disposed between the contact plates and is disposed inside the housing. The actuator has a slot for receiving the bipolar plate. The actuator is movable between an extended position, wherein the actuator is disposed between the contact elements so as to separate the contact elements, and a retracted position, wherein the actuator is not disposed between the contact elements.

### CROSS-REFERENCE TO RELATED APPLICATION(S)

This application claims the benefit of priority under 35 U.S.C. § 119(e) to U.S. Provisional Patent Application No. 63/093,645 filed on 19 Oct. 2020, which is herein incorporated by reference.

### TECHNICAL FIELD

This disclosure relates generally to connectors and, more particularly, to connectors for connecting bipolar plates of a fuel cell stack to a voltage measuring and monitoring system.

### BACKGROUND

Fuel cells are a source of clean energy that are being used in a number of different applications, including automotive applications. One type of fuel cell that is commonly utilized is a polymer electrolyte membrane (PEM) fuel cell, which has a membrane electrode assembly that includes a PEM, anode and cathode catalyst layers disposed on opposing sides of the PEM and gas diffusion layers disposed on outer sides of the catalyst layers, respectively. In most applications, a plurality of PEM fuel cells is provided in a stack, in which each PEM fuel cell includes a membrane electrode assembly disposed between a pair of bipolar plates. The bipolar plates may be comprised of a metal, such as coated stainless steel, carbon (e.g. graphite), or a composite. The bipolar plates connect the cells together electrically and provide physical strength to the stack. Flow fields in the form of channels may be formed in the bipolar plates to allow gases to flow over the cell. The bipolar plates are thin, typically having a thickness of less than 6 mm and more usually around 1 mm.

In order to monitor the performance of a PEM fuel cell stack, the bipolar plates are connected to a monitoring circuit that measures and monitors the voltage across each fuel cell. The compact size of a fuel cell stack, the numerous connections that must be made, the thinness of the bipolar plates and the vibratory environment in which a fuel cell stack is often utilized present a number of technical issues that must be addressed. For example, a voltage pickup connector for a fuel cell system should be able to accommodate wide plate-to-plate tolerances and should exert a high contact force on a bipolar plate, without damaging or causing excessive wear of the bipolar plate or the contacts of the connector. Conventional fuel cell voltage pickup connectors often do not fully meet these requirements. Accordingly, there is a need in the art for a fuel cell voltage pickup connector that does meet these requirements.

### SUMMARY

In accordance with the disclosure, a voltage pick-up connector is provided for a bipolar plate of a fuel cell. The voltage pick-up connector includes a housing having a housing slot with a front opening for receiving the bipolar plate. The front opening is in a front portion of the housing. A pair of electrically conductive contact plates are at least partially disposed inside the housing. Each of the contact plates has at least one contact element for engaging the bipolar plate. An actuator is disposed between the contact plates and is at least partially disposed inside the housing. The actuator has a slot for receiving the bipolar plate and a blocking portion with at least one engagement structure. The actuator is movable between an extended position and a retracted position. When the actuator is in the extended position, the blocking portion is disposed between the contact elements so as to separate the contact elements. In addition, the at least one engagement structure engages at least one of the contact elements, and a frontmost portion of the actuator is disposed closer to the front opening of the housing than frontmost portions of the contact plates. When the actuator is in the retracted position, the blocking portion is disposed rearward from the contact elements and does not separate the contact elements.

### BRIEF DESCRIPTION OF THE DRAWINGS

The features, aspects, and advantages of the present invention will become better understood with regard to the following description, appended claims, and accompanying drawings where:

FIG. 1 shows a perspective view of portions of a pair of fuel cell stacks connected to a connector assembly;

FIG. 2 shows a top, side perspective view of a connector connected to a bipolar plate of one of the fuel stacks;

FIG. 3 shows a top, front perspective view of the connector;

FIG. 4 shows a partially exploded side perspective view of the connector;

FIG. 5 shows a side perspective view of contact plates and an actuator of the connector;

FIG. 6 shows a rear, side sectional perspective view of the connector, with one of the contact plates removed;

FIG. 7 shows a perspective side sectional view of the connector;

FIG. 8 shows a side schematic view of the connector, wherein the actuator is in an extended position;

FIG. 9 shows a side schematic view of the connector, wherein the actuator is in a retracted position;

FIG. 10 shows a side schematic view of the connector connected to a bipolar plate having protrusions;

FIG. 11 shows a side schematic view of the connector having a pair of connector position assurance structures mounted thereto;

FIG. 12 shows a close-up top view of a portion of the connector assembly of FIG. 1, with parts removed for better illustration; and

FIG. 13 shows a portion of the connector assembly of FIG. 1

### DETAILED DESCRIPTION OF ILLUSTRATIVE EMBODIMENTS

It should be noted that in the detailed description that follows, identical components have the same reference numerals, regardless of whether they are shown in different embodiments of the present disclosure. It should also be noted that for purposes of clarity and conciseness, the drawings may not necessarily be to scale and certain features of the disclosure may be shown in somewhat schematic form.

Spatially relative terms, such as “top”, “bottom”, “lower”, “above”, “upper”, and the like, are used herein merely for ease of description to describe one element or feature's relationship to another element(s) or feature(s) as they are illustrated in (a) drawing figure(s) being referred to. It will be understood that the spatially relative terms are not meant to be limiting and are intended to encompass different orientations of the device in use or operation in addition to the orientation depicted in the drawings.

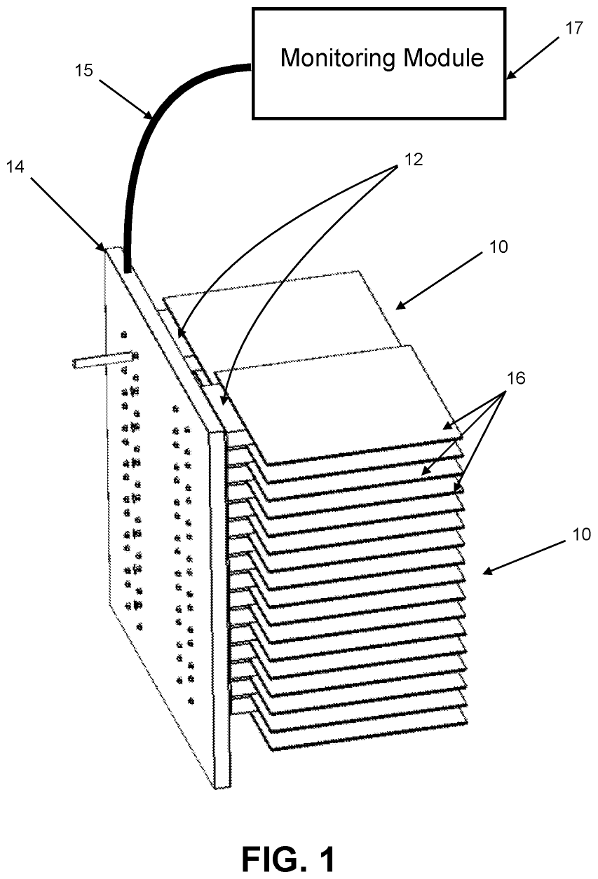

Referring now to FIG. 1, there is shown portions of a pair of fuel cell stacks 10 connected to a plurality of connectors 12 mounted to a support circuit board 14. More specifically, bipolar plates 16 of the fuel cell stacks 10 are physically and electrically connected to the connectors 12. The fuel cell stacks 10 may be comprised of PEM fuel cells, each of which includes a membrane electrode assembly comprising a PEM, anode and cathode catalyst layers disposed on opposing sides of the PEM and gas diffusion layers disposed on outer sides of the catalyst layers, respectively. The membrane electrode assembly is disposed between a pair of the bipolar plates 16.

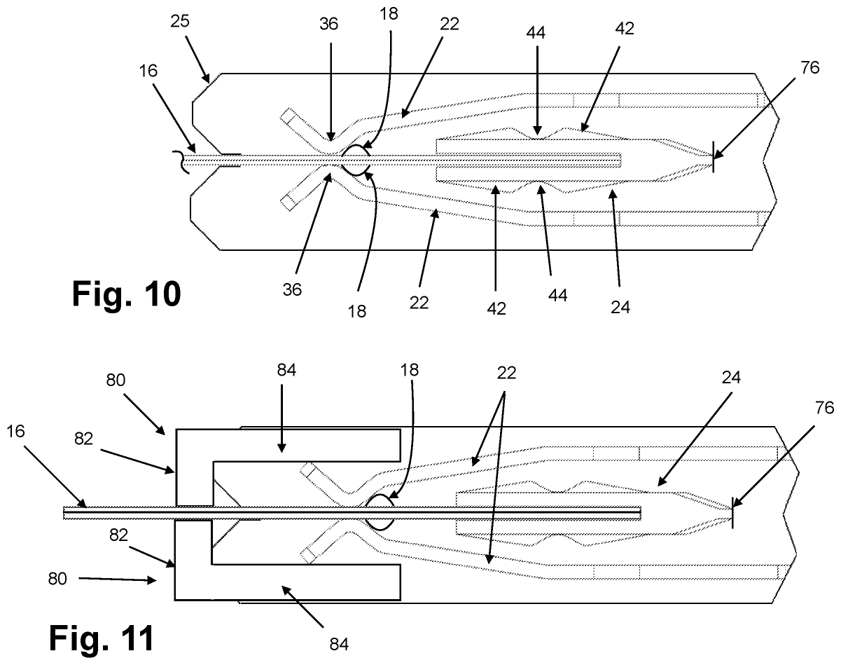

The bipolar plates 16 may be constructed of carbon (such as graphite), metal, or a composite. Suitable metals that may be used include stainless steel, aluminum, titanium and nickel, which may be coated with a carbon- or metal-based coating to prevent electrically insulating surface passivation and metal ion dissolution. Suitable composites include carbon-polymer composites, such as a dispersion of graphite, carbon black, carbon fibers, and/or carbon nanotubes in a polymer matrix that may be polypropylene, polyphenylene sulfide, polyvinylidene fluoride or a phenolic resin. Flow fields in the form of channels may be formed in the bipolar plates 16 to allow gases to flow over the cells of the fuel cell stacks 10. Depending on their composition, the bipolar plates 16 may each have a thickness in a range of from about 0.1 mm to about 4 mm and a typical area of from about 10 cm² to about 100 cm². As will be described in more detail below, each bipolar plate 16 may have protrusions 18 formed on opposing sides of the bipolar plate 16, toward a leading edge thereof, as shown in FIGS. 10 and 11.

The connectors 12 electrically connect the bipolar plates 16 to the support circuit board 14 such that signals for measuring the voltage across each pair of the bipolar plates 16 are routed through the support circuit board 14 to a link 15 that transmits the voltage signals to a monitoring module 17 that measures and monitors the voltages.

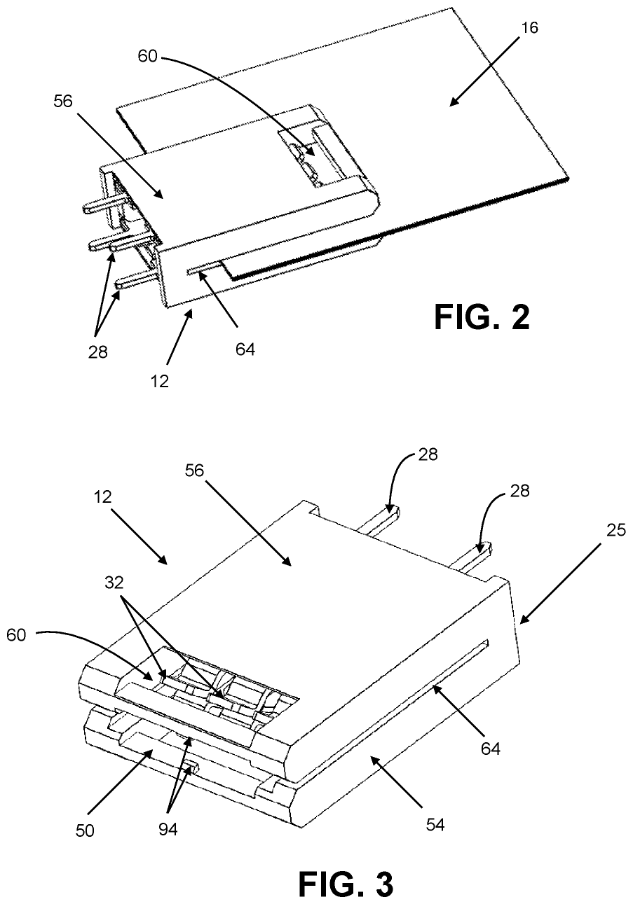

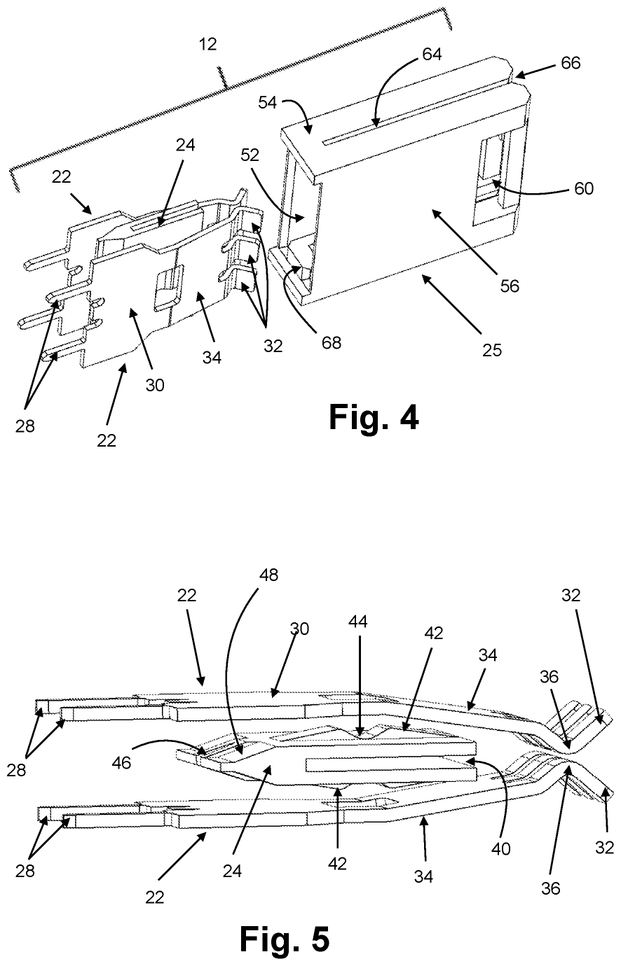

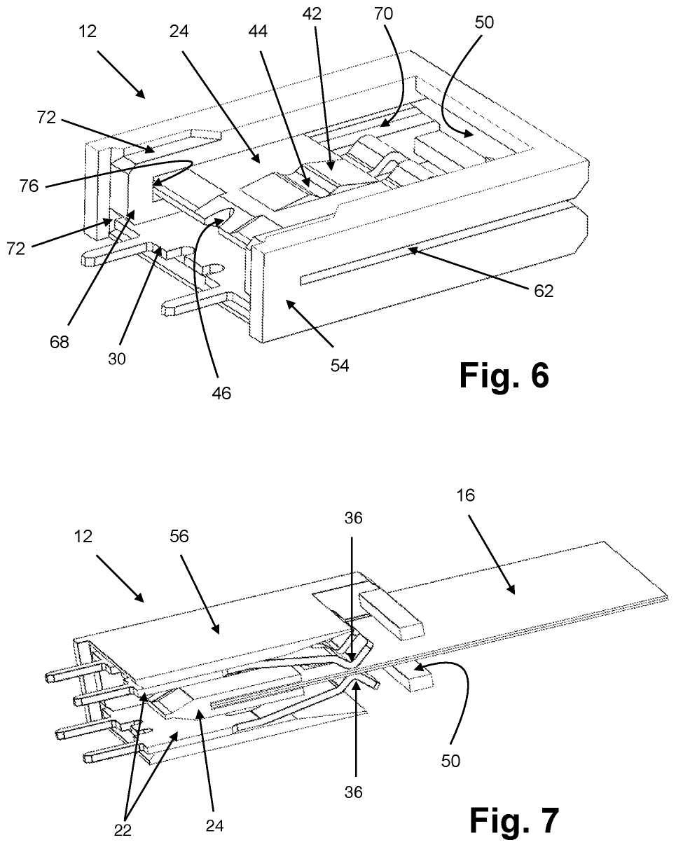

Referring now to FIGS. 2-7, each connector 12 includes a pair of contact plates 22 and a shuttle or actuator 24 mounted inside an outer housing 25.

Each contact plate 22 is comprised of conductive metal, such as copper or a copper alloy, which may be coated with tin or another metal. Each contact plate 22 includes a main body having a rear body portion 30 with a plurality of mounting structures 28 extending therefrom and a front body portion 34 with a plurality of contact fingers 32 extending therefrom. The mounting structures 28 may, as shown, be straight pins for soldering into plated holes in the support circuit board 14. Alternately, the mounting structures 28 may be pins having press-fit fasteners that are pressed into the plated holes of the support circuit board 14. Exemplary pins with press-fit fasteners include those with an eye-of-the-needle (EON) construction. In other embodiments, the mounting structures 28 may be crimps for securement to wires, or surface mount connectors.

The main bodies of the contact plates 22 are slightly bent such that the front body portions 34, and the contact fingers 32, slope inward, toward each other. Each contact finger 32 is generally L-shaped, having inner and outer portions joined at bends 36, with the outer portions extending outward. The contact fingers 32 in one of the contact plates 22 are aligned with the contact fingers 32 in the other one of the contact plates 22 so as to form pairs of opposing contact fingers 32. The bends 36 of the opposing contact fingers 32 would abut each other but for the actuator 24 or the bipolar plate 16. In other words, the bends 36 in one contact plate 22 are biased toward the bends 36 in the other contact plate 22. As will be described more fully below, the bends 36 in each pair of opposing contact fingers 32 press against opposing sides of a bipolar plate 16 to hold and make electrical contact therewith.

The actuator 24 is movably disposed between the contact plates 22, as described more fully below. The actuator 24 is comprised of an electrically insulating plastic and defines a slot 40 sized to receive a bipolar plate 16. The slot 40 has an opening formed in a front end portion of the actuator 24. Opposing top and bottom surfaces of the actuator 24 each have a ridge 42 with an indentation 44 formed therein. The width of each ridge 42 and, thus, its indentation 44 may be limited to a center portion of the actuator 24 (as shown) or may extend across the entire width of the actuator 24, depending on how many bends 36 of a contact plate 22 are to be disposed in the indentation 44. A posterior end portion of the actuator 24 has a rearwardly-directed slot or notch 46 formed therein. As described more fully below, the notch 46 is aligned with an opening in the support 14 and is adapted to receive an end of a push rod 90. The actuator 24 may have opposing tapered posterior surfaces 48 to facilitate the insertion of the contact plates 22 into the housing 25 through a rear opening 52 of the housing 25 during the manufacture of the connector 12. The tapered posterior surfaces 48 help spread the front body portions 34 of the contact plates 22 as they are being inserted.

The housing 25, which may be formed of insulating plastic, is cuboidal and has a front portion with a front opening 50 formed therein and a rear portion with a rear opening 52 formed therein. The housing 25 includes a pair of side walls 54 joined between a pair of major walls 56 having openings 60 therein. The front opening 50 cooperates with slots 62 in the side walls 54 to form a housing slot 64 in the housing 25. Front end portions of each side wall 54, on opposing sides of the slot 62, are tapered to form a guide area 66 for guiding a bipolar plate 16 into the housing slot 64. Each side wall 54 has an interior mount 68 that defines a central guide groove 70. The slots 62 in the side walls 54 extend through the guide grooves 70, respectively. In each side wall 54, the interior mount 68 also helps define a pair of spaced-apart holding grooves 72.

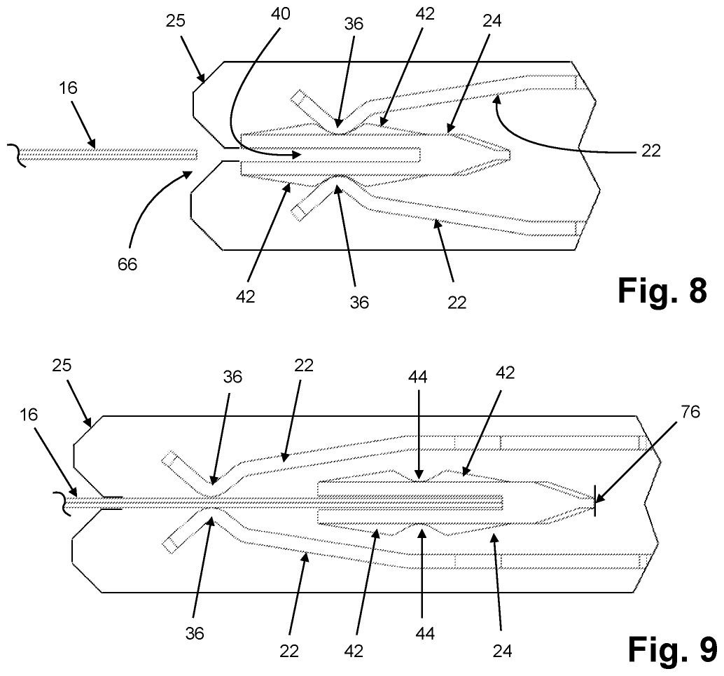

Inside the housing 25, the rear portions 30 of the contact plates 22 are held in the holding grooves 72, respectively, in a spaced-apart manner. The actuator 24 is disposed between the contact plates 22 and is movably mounted to the mounts 68, with side portions of the actuator 24 being slidably disposed in the guide grooves 70, respectively. The actuator 24 is movable between an extended position and a retracted position, as depicted schematically in FIGS. 8 and 9. In the extended position, the actuator 24 is disposed proximate to the front opening 50 in the housing 25, whereas in the retracted position, the actuator 24 is disposed distal to the front opening 25. When the actuator 24 is in the extended position, a frontmost portion of the actuator 24 is disposed forward from frontmost portions of the contact fingers 32, i.e., is closer to the front opening 50. In addition, at least one bend 36 of one of the contact plates 22 is disposed inside the indentation 44 of one of the ridges 42, while at least one bend of the other one of the contact plates 22 is disposed inside the indentation 44 of the other one of the ridges 42. In this manner, the actuator 24 is held in the extended position by the bends 36 in at least one pair of opposing contact fingers 32 in the two contact plates 22. The pair of opposing contact fingers 32 may be a middle pair of the opposing contact fingers 32. When the actuator 24 is in the retracted position, the actuator 24 is disposed rearward from the bends 36 and a posterior end of the actuator 24 abuts inner end walls 76 of the mounts 68, respectively. Notably, movement of the actuator 24 between the extended and retracted positions causes movement of the front body portions 34 of the contact plates 22 toward and away from each other, as discussed more fully below.

Referring now to FIG. 8, a bipolar plate 16 is shown aligned with a connector 12 in preparation for being mounted thereto. More specifically, a leading edge of the bipolar plate 16 is disposed in the guide areas 66 of the housing 25 and the actuator 24 is in the extended position so as to separate the front body portions 34 (and, more specifically, the bends 36) of the contact plates 22. A force is then applied to the bipolar plate 16 to move the bipolar plate 16 into the housing slot 64 and thence the slot 40 of the actuator 24, with the actuator 24 being held steady by the interplay of the bends 36 with the indentations 44. As the bipolar plate 16 continues to be moved rearward, toward the support circuit board 14, the bipolar plate 16 moves the actuator 24 out of engagement with the bends 36 and thence all of the front body portions 34 of the contact plates 22. As the actuator 24 moves out of engagement with the front body portions 34, the front body portions 34 of the contact plates 22 move resiliently inward, toward each other, which brings the bends 36 of the contact plates 22 into engagement with opposing sides of the bipolar plate 16. The actuator 24 continues rearward until the posterior end of the actuator 24 abuts the inner end walls 76 of the mounts 68, at which point, the actuator 24 is in the retracted position, as shown in FIG. 9. The bipolar plate 16 is now firmly held between the contact plates 22 by the bends 36 and is in electrical contact therewith, i.e., the bipolar plate 16 is in a connected position. More specifically, the bends 36 in each pair of opposing contact fingers 32 are pressed against the bipolar plate 16 (with high normal forces) at the same location, except for on opposing sides of the bipolar plate 16. This helps ensure good contact performance with high normal force, but without deforming the thin bipolar plate 16.

In order to better secure the bipolar plate 16 in the connected position, the bipolar plate 16 may have protrusions 18 formed on opposing sides of the bipolar plate 16, toward the leading edge thereof, as shown in FIGS. 10 and 11. More specifically, the protrusions 18 are spaced from the leading edge of the bipolar plate 16 such that when the leading edge portion of the bipolar plate 16 is disposed in the slot 40 of the actuator 24, the protrusions 18 are spaced from the actuator 24 and, when the actuator 24 is in the extended position, the protrusions 18 may be at least partially disposed outside the housing 25. As the bipolar plate 16 is pushed rearward, toward the connected position, and the actuator 24 moves out of engagement with the front body portions 34 and the front body portions 34 subsequently move inward, the protuberances 18 then engage the contact fingers 32 and move them outwardly to allow the protuberances 18 to pass therebetween. The curved shape of the protuberances 18 cooperates with the sloped shape of the outer portions of the contact fingers 32 to move the contact fingers 32 outward.

When the bipolar plate 16 is in the connected position, each protrusion 18 is disposed rearward of the bend 36 of at least one of the contact fingers 32 and abuts an inner portion thereof. With the protuberances 18 so positioned, in order for the bipolar plate 16 to move out of the connected position, an increased force must be applied to the bipolar plate 16 that is sufficient to separate the contact fingers 32 to permit the protrusions 18 to pass therebetween. This requirement for an increased force helps maintain the bipolar plate 16 in the connected position. Each protuberance 18 may be sized to engage only one contact finger 32, such as a middle contact finger (as shown), or may be sized to engage all of the contact fingers 32 of a contact plate 22.

Instead of using protrusions to help secure the bipolar plate 16 in the connected position, one or more holes may be formed in the bipolar plate 16, wherein the holes are positioned such that the bends 36 of opposing contact fingers 32 are disposed in the holes when the actuator 24 is in the retracted position. Latches may also be used to hold the bipolar plate 16 in the connected position.

In addition to, or in lieu of, the protrusions 18, openings and/or latches, the connector 12 may be provided with one or more connector position assurance (CPA) structures 80 that help keep the bipolar plate 16 in the connected position. As shown in FIG. 11, a pair of CPA structures 80 may be utilized. Each CPA structure 80 has an L-shaped cross-section and includes an end wall 82 joined at about a right angle to an arm 84 that extends forward therefrom. The arms 84 extend into the housing 25 (such as through the openings 60) and engage the contact fingers 32 of the contact plates 22, respectively, so as to press them inward and maintain an inwardly-directed pressure on the bends 36, which are abutting the bipolar plate 16. Free edges of the end walls 82 are disposed against opposing sides of the bipolar plate 16 and help prevent movement of the bipolar plate 16.

Referring now to FIGS. 1 and 12-13, the bipolar plate 16 may be disconnected and removed from the connector 12, by moving the actuator 24 back to the extended position. This may be accomplished using a push rod 90. The push rod 90 may be inserted through a rod opening 92 in the support circuit board 14 and into the notch 46 in the actuator 24. The release rod 90 is then pushed forward, moving the actuator 24 and the bipolar plate 16 forward. If the bipolar plate 16 has the protrusions 16, rounded surfaces of the protrusions 18 contact the sloping inner portions of the contact fingers 32 in a camming manner that translates a portion of the forward movement into movement of the contact fingers 32 away from each other, thereby allowing the protrusions 16, followed by the actuator 24, to pass between the contact fingers 32. If the bipolar plate 16 does not have the protrusions 18, a sloping front surface of the actuator 24 contacts the sloping inner portions of the contact fingers 32 in a camming manner that translates a portion of the forward movement into movement of the contact fingers 32 away from each other, thereby allowing the actuator 24, to pass between the contact fingers 32.

The push rod 90 is pushed forward until the front end of the actuator 24 abuts a pair of inwardly extending retention tabs 94 of the housing 25 (shown in FIG. 3), at which point the actuator 24 is in the extended position. With the actuator 24 in the extended position, the bipolar plate 16 is no longer held between the bends 36 of opposing contact fingers 32 and, as such, can be easily removed from the housing slot 64 and away from the connector 12.

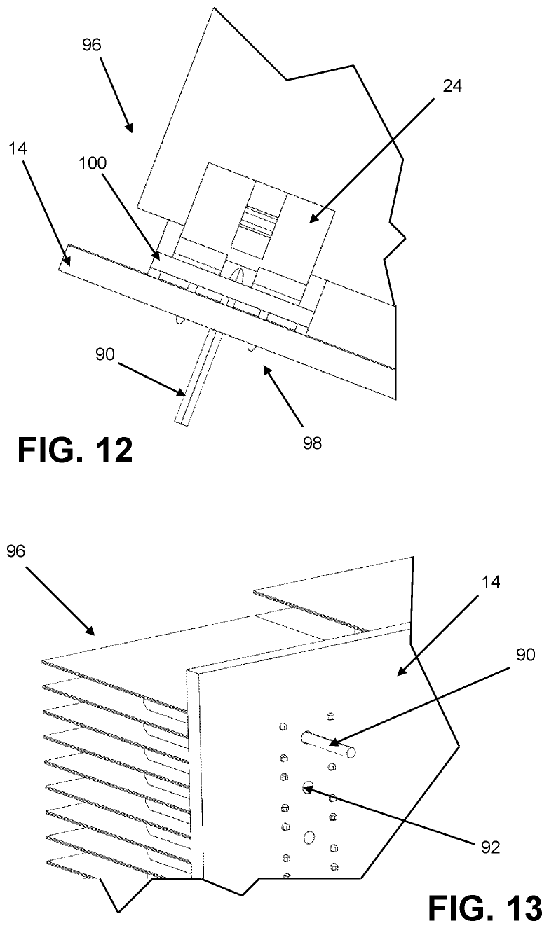

As shown in FIGS. 12-13, each connector 12 may be part of an assembly 96 that is connected to a plurality of bipolar plates 16, such as all of the bipolar plates 16 of a fuel cell stack 10. In such a connector assembly 96, the housings 25 of the connectors 12 may be integrally joined together in a unitary housing 98. In such an embodiment, the unitary housing 98 may include a back wall 100 integrally joined to posterior ends of the side walls 54 of the housings 25. In this embodiment, rod openings in the back wall 100 would be aligned with the rod openings 92 in the support circuit board 14 and the notches 46 in the actuators 24 such that a push rod 90 could be inserted through the rod openings in both the support circuit board 14 and the back wall 100 to engage the actuator 24 of a connector 12.

Although not shown, in some embodiments, the connector 12 may be provided with a spring biasing arrangement to bias the actuator 12 toward the extended position. In such embodiments, the push rod 90 may be dispensed with or may still be utilized to manually help move the actuator 24 from the retracted position to the extended position. In other embodiments, such a spring biasing arrangement is not desirable and the connector 12 therefore does not have any spring biasing arrangement.

It should be appreciated that the connector 12 of the present disclosure provides a number of benefits over conventional fuel cell voltage connectors. Due to its thinness, a bipolar plate that is to be inserted between a pair of contacts cannot adequately deflect the contacts if the contacts are to subsequently provide high normal forces against the bipolar plate. Lowering the normal forces applied by the contacts is not desirable because it results in unstable contact performance when the connector and/or the bipolar plate are subjected to shock, vibration or micro movement. The connector 12 addresses this issue by utilizing the actuator 24 to pre-load the contact plates 22, i.e., space apart the contact plates 22 against their biases. The actuator 24 pre-loads the contact plates 22 when the bipolar plate 16 is inserted into the housing slot 64 and positioned between the contact plates 22. As the bipolar plate 16 is pushed toward the connected position, the actuator 24 moves out of engagement with the contact plates 22, thereby allowing the contact plates 22 to move inward and press the bends 36 into engagement with opposing sides of the bipolar plate 16. In this manner, the contact plates 22 are able to apply high normal forces to the bipolar plate 16 without damaging the bipolar plate 16 or experiencing excessive wear (through wiping) when the bipolar plate 16 is positioned between the contact plates 22.

It is to be understood that the description of the foregoing exemplary embodiment(s) is (are) intended to be only illustrative, rather than exhaustive. Those of ordinary skill will be able to make certain additions, deletions, and/or modifications to the embodiment(s) of the disclosed subject matter without departing from the spirit of the disclosure or its scope.

What is claimed is:

1. A voltage pick-up connector for a bipolar plate of a fuel cell, the voltage pick-up connector comprising:
a housing having a housing slot with a front opening for receiving the bipolar plate, the front opening being in a front portion of the housing;
a pair of electrically conductive contact plates at least partially disposed inside the housing, each contact plate having at least one contact element for engaging the bipolar plate; and
an actuator disposed between the contact plates and at least partially disposed inside the housing, the actuator having a slot for receiving the bipolar plate and a blocking portion with at least one engagement structure, the actuator being movable between an extended position and a retracted position;
wherein when the actuator is in the extended position:
the blocking portion is disposed between the contact elements so as to separate the contact elements;
the at least one engagement structure engages at least one of the contact elements; and
a frontmost portion of the actuator is disposed closer to the front opening of the housing than frontmost portions of the contact plates; and
wherein when the actuator is in the retracted position, the blocking portion is disposed rearward from the contact elements and does not separate the contact elements.

2. The voltage pick-up connector of claim 1, wherein the at least one engagement structure comprises indentations in opposing sides of the actuator, and wherein when the actuator is in the extended position, at least a portion of one of the contact elements is disposed in each of the indentations.

3. The voltage pick-up connector of claim 2, wherein the contact elements each comprise an inwardly-directed bend, and wherein the bend of one of the contact elements is disposed in each of the indentations.

4. The voltage pick-up connector of claim 3, wherein the contact elements are each L-shaped.

5. The voltage pick-up connector of claim 4, wherein each of the contact plates has a plurality of contact elements.

6. The voltage pick-up connector of claim 1, wherein each of the contact plates has a mounting structure for securement to a circuit board.

7. The voltage pick-up connector of claim 6, wherein the mounting structures comprise pins for soldering into plated holes of the circuit board.

8. The voltage pick-up connector of claim 6, wherein the mounting structures comprise pins having press-fit fastening portions for press-fit insertion into plated holes of the circuit board.

9. The voltage pick-up connector of claim 1, wherein the housing comprises side walls joined between major walls, wherein the housing slot extends through the side walls, and wherein the major walls have access openings formed therein.

10. The voltage pick-up connector of claim 9, further comprising a pair of connector position assurance (CPA) structures for maintaining the connection between the contact elements and the bipolar plate, each of the CPA structures having an end wall joined at about a right angle to an arm that extends forward therefrom, the arms being adapted for insertion into the access openings, respectively, to engage the at least one contact element of each of the contact plates, respectively, so as to press them inward toward each other.

11. The voltage pick-up connector of claim 1, wherein the housing has a rear opening and a rear portion of the actuator has a notch formed therein, and wherein the voltage pick-up connector further comprises a push rod for insertion through the rear opening in the housing and into engagement with the notch of the actuator to push the actuator from the retracted position to the extended position.

12. A connector assembly comprising a plurality of the voltage pick-up connectors of claim 1, and wherein the housing of each of the voltage pick-up connectors is integrally joined with the housing of at least another one of the voltage pick-up connectors.

13. In combination, the voltage pick-up connector of claim 1 and a bipolar plate of a fuel cell, the bipolar plate having opposing first and second surfaces, and wherein when the bipolar plate is in housing slot and the actuator is in the retracted position, the bipolar plate is in a connected position in which the at least one contact element of a first one of the contact plates presses against the first surface of the bipolar plate and the at least one contact element of a second one of the contact plates presses against the second surface of the contact plate.

14. The combination of claim 13, wherein the bipolar plate has a first protrusion on the first surface and a second protrusion on the second surface, and wherein when the bipolar plate is in the housing slot and the actuator is in the retracted position, the protrusions are disposed rearward from the contact elements of the contact plates, thereby helping keep the bipolar plate in the connected position.

15. A method of using the voltage pick-up connector of claim 1, wherein the actuator is initially in the extended position, the method comprising:
providing a bipolar plate having opposing first and second surfaces;
inserting the bipolar plate into the housing slot through the front opening of the housing and pushing the bipolar plate rearward through the housing slot such that a leading edge portion of the bipolar plate enters the slot of the actuator and thence moves the actuator rearward until the actuator reaches the retracted position, whereby the rearward movement of the actuator from between the contact element causes the at least one contact element of a first one of the contact plates to move inward and press against the first surface of the bipolar plate and the at least one contact element of a second one of the contact plates to move inward and press against the second surface of the contact plate, thereby placing the bipolar plate in a connected position in which the bipolar plate is physically and electrically connected to the contact plates of the voltage pick-up connector.

16. The method of claim 15, wherein the housing comprises side walls joined between major walls, wherein the housing slot extends through the side walls, and wherein the major walls have access openings formed therein, and wherein the method further comprises:
providing a pair of connector position assurance (CPA) structures, each having an end wall joined at about a right angle to an arm that extends forward therefrom;
manipulating the CPA structures to:
move the arms through the access openings, respectively, such that the arms engage the at least one contact element of each of the contact plates, respectively, so as to press them against the bipolar plate; and
position free ends of the end walls against the first and second surfaces of the bipolar plate, respectively, thereby holding the bipolar plate between the CPA structures.

17. The method of claim 15, wherein the bipolar plate has a first protrusion on the first surface and a second protrusion on the second surface, the first and second protrusions being spaced from the leading edge portion of the bipolar plate such that when the leading edge portion of the bipolar plate is disposed in the slot of the actuator, the first and second protrusions are spaced from the actuator, whereby as the bipolar plate is pushed rearward and the actuator moves out from between the contact elements and the contact elements subsequently move inward, the first and second protuberances then engage the contact elements and move them outwardly to allow the first and second protuberances to pass therebetween.

18. The method of claim 17, wherein when the actuator is in the retracted position, the first and second protrusions are disposed rearward from the contact elements of the contact plates, thereby helping keep the bipolar plate in the connected position.

19. The method of claim 15, wherein the housing has a rear opening and a rear portion of the actuator has a notch formed therein, and wherein the method further comprises:
providing a push rod; and
inserting the push rod through the rear opening in the housing and into engagement with the notch of the actuator and then moving the push rod to move the actuator from the retracted position to the extended position; and
sliding the bipolar plate out of the housing slot.

20. The method of claim 19, wherein each of the contact plates has a mounting structure, and wherein the method further comprises:
before inserting the bipolar plate into the housing slot, securing the mounting structures of the contact plates to a circuit board having a rod opening; and
wherein the step of inserting and moving the push rod comprises inserting the push rod through the rod opening in the circuit board and thence through the rear opening in the housing.
